(19) United States
(12) Patent Application Publication
(10) Pub. No.: US 2025/0053661 A1
(43) Pub. Date: Feb. 13, 2025

(54) METHOD AND A SYSTEM FOR DEVELOPER IDENTIFICATION AND TICKET ASSIGNMENT

(71) Applicant: ArmorCode Inc., FREMONT, CA (US)

(72) Inventors: ANANT MISRA, CUPERTINO, CA (US); NIKHIL GUPTA, SARATOGA, CA (US); Praneet Khare, Bangalore (IN); Deepak Yadav, Gurgaon (IN)

(21) Appl. No.: 18/366,515

(22) Filed: Aug. 7, 2023

Related U.S. Application Data
(60) Provisional application No. 63/349,569, filed on Jun. 6, 2022.

(51) Int. Cl. G06F 21/57; G06F 8/71

(52) U.S. Cl. CPC G06F 21/577; G06F 8/71

(57) ABSTRACT

The embodiments herein provide a method and a system for developer identification and ticket assignment. The method comprises applying owner identification logics through a plurality of application security testing methodologies such as SAST, DAST and SCA tool. The method further comprises making an API call through a vulnerability management platform to a code repository to identify the developer who has changed the portion of the code recently; assigning a ticket to the identified developer and saving the developer in the vulnerability management platform; viewing the status of the ticket through various options such as insight view, CTO view, Engineering Manager view and Developer view; and providing training requirements and assessing the effectiveness of training.

### CROSS-REFERENCE TO RELATED APPLICATIONS

The present application claims the priority from the Indian Provisional Application with Ser. No. 63/349,569 filed on Jun. 6, 2022, with the title “A METHOD AND A SYSTEM FOR DEVELOPER IDENTIFICATION AND TICKET ASSIGNMENT. The contents of the abovementioned Application are included in entirety as reference herein.

### BACKGROUND

### Technical Field

The embodiments herein are generally related to the field of application security. The embodiments herein are more particularly related to a method and a system for developer identification and ticket assignment.

### Description of the Related Art

Application Security requires the security team and the development team to work together. Traditionally, these teams work in silos and do not interact with each other often. Hence, the security teams often do not have access to all the code repositories and the developer tools. As a result, they do not have sufficient information to assign a developer or an owner to a vulnerability/ticket.

As a result, the security team would assign issues to a CTO, or an engineering manager or just leave them unassigned, implicitly leaving it again on someone else to identify the developer responsible to fix the identified vulnerabilities, thereby resulting in huge delays between identifying a vulnerability and final fix deployed to production. Furthermore, the problem gets amplified by agile release life cycles and developer churn.

Hence, in view of this, there is a need for a method and a system for developer identification and ticket assignment, such that the method and system manage remediation of delays in assigning the ticket to the developers.

The above-mentioned shortcomings, disadvantages and problems are addressed herein, and which will be understood by reading and studying the following specification.

### OBJECTIVES OF THE EMBODIMENTS HEREIN

The primary object of the embodiments herein is to provide a method and a system for developer identification and ticket assignment.

Another object of the embodiments herein is to provide a method and a system for developer identification and ticket assignment, such that the method and system manage remediation of delays in assigning the ticket to developers.

Yet another object of the embodiments herein is to provide a method and a system for identifying developers automatically.

Yet another object of the embodiments herein is to provide a method and a system for streamlined ticket assignment.

Yet another object of the embodiments herein is to provide a method and a system for seamless integration with version control.

Yet another object of the embodiments herein is to provide a method and a system for providing comprehensive ticketing views.

Yet another object of the embodiments herein is to provide a method and a system for providing effective training requirements.

Yet another object of the embodiments herein is to provide a method and a system for evaluating the effectiveness of the training provided.

Yet another object of the embodiments herein is to provide a method and a system providing a centralized platform for managing security issues, training requirements, and ticketing status.

These and other objects and advantages of the present invention will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

This Summary is provided to introduce a selection of concepts in a simplified form that is further described below in the Detailed Description. This Summary is not intended to identify key or essential features of the claimed subject matter, nor is it intended to be used as an aid in determining the scope of the claimed subject matter.

The various embodiments herein provide a computer-implemented method and system for developer identification and ticket assignment. The method for developed identification and ticket assignment is provided. The method comprises applying an owner identification logic through a plurality of application security testing methodologies. The plurality of application security testing methodologies comprises Static Application Security Testing (SAST), Dynamic Application Security Testing (DAST), and Software Composition Analysis (SCA) tool. The method further comprises making an Application Programming Interface (API) call through a vulnerability management platform, to a code repository (GitHub, Gitlab etc.,), where a codebase is stored, to identify the changes made by a developer to the code recently. In addition, the method comprises assigning a ticket to the identified developer and saving a developer's information in the vulnerability management platform. Furthermore, the method comprises viewing the status of the ticket through a plurality of views. The plurality of views comprises an insight view, a CTO view, an engineering manager view, and a developer view. Further, the method comprises providing training requirements and assessing the effectiveness of the training provided.

According to one embodiment herein, the owner identification logic involves utilizing data from the plurality of application security testing methodologies in conjunction with the information obtained from the code repository to identify an exact line number of a code, where a security issue is found or vulnerability dependency is defined. The combined results of SAST, DAST, and SCA testing provide information about potential security issues in the codebase. Therefore, the method determines the exact line number in the source code where each security issue is found or where the vulnerable dependency is defined. In addition, the SAST application security testing methodology is configured to identify vulnerability dependency on an exact line number of the code. The DAST application security testing methodology is configured to identify vulnerability dependency on the codebase and file or line of code, and using the line of code and the API call to identify the developer who committed the code using the line of code. The SCA tool is configured to identify the vulnerability dependency and license issues in an open source and software libraries, or components included in the codebase.

According to one embodiment herein, the Application Programming Interface (API) call made through the vulnerability management platform retrieves the information about the recent changes made to the codebase of the code repository (e.g., GitHub, GitLab, etc.) and also identifies which developer has made changes to the portion of the codebase where the security issue or the vulnerability dependency is found.

According to one embodiment herein, the ticket assigned to the identified developer is updated in a tracking system, such as JIRA, or ServiceNow to track the security issue and its resolution. The security issue is assigned to the identified developer for further investigation and resolution. Hence, the security issues in the codebase can be efficiently addressed and assigned to the relevant developers, streamlining the process of remediation and ensuring a secure and reliable application.

According to one embodiment herein, if the identified developer is registered on the vulnerability management platform, the ticket is directly assigned to the identified developer, and if the identified developer is not registered on the vulnerability management platform, an email address or similar unique identifier is used for the ticket assignment and identification.

According to one embodiment herein, the developer information includes the developer who last amended the code or file or code repository. If the developer information is not available on the vulnerability management platform, then an engineering owner of a product or security owner, or business owner as configured during product creation is assigned the ticket, and in default, a default assignee or the developer as configured in a rulebook is also assigned with the ticket. A rulebook is a set of rules that define how the software should behave in certain situations. It is a way of defining the logic of an application in a structured way. Rulebooks are used in many different types of software applications, including business applications, games, and web applications.

According to one embodiment herein, the plurality of views are interfaces or different perspectives within the vulnerability management platform, that cater to specific stakeholders involved in the security issue resolution process, and each of the plurality of views provides relevant information and functionalities tailored to the needs of the respective role.

According to one embodiment herein, the insight view is a high-level overview or dashboard within the vulnerability management platform that provides a comprehensive summary of the overall security posture of the codebase. The insight view is configured to provide findings by the developers, for creating one ticket for multiple findings and assigning to the developer directly. In addition, the insight view is typically designed for executives, security leaders, or other high-level stakeholders who need a quick and easily digestible snapshot of the security status of the organization's software projects. The insight view includes metrics, charts, and graphs to represent the number of open security issues, their severity, trends over time, and other key security-related data. Furthermore, the insight view enables decision-makers to assess the overall security health of the software projects and take appropriate actions or allocate resources as needed.

According to one embodiment herein, the Chief Technology Officer (CTO) view is a specific interface within the vulnerability management platform tailored for the CTO or other high-level technology executives, and the CTO view is configured to provide individual teams' performance information including the teams that are doing an excellent job of writing secure code and the teams that are not performing well. Further, the CTO view also provides a more detailed and strategic perspective compared to the insight view, focusing on the security status and progress of various projects and teams under the CTO's purview. In addition, the CTO view also offers aggregated metrics for multiple projects, allowing the CTO to evaluate the organization's security initiatives, identify potential areas of concern, and make strategic decisions related to security investments, team training, and project priorities.

According to one embodiment herein, the Engineering Manager view is configured to provide the engineering manager with the team's performance at a developer level. The Engineering Manager view also provides a more granular and operational level of information related to security issues and tickets assigned to their teams. The Engineering manager view is used by the Engineering managers to track the progress of security issue resolutions, monitor the workload and performance of their team members, and ensure that security priorities align with project timelines.

According to one embodiment herein, the developer view is a user interface specifically tailored for individual developers who are assigned tickets to address the security issues. The developer view also provides details of the security issues assigned to them, including the exact line number of the code where the security issue is found, along with any supporting information from the plurality of application security testing methodologies. The developers use the developer view to access the necessary information to understand the security issue, review any relevant testing results, work on resolving the issue in the codebase; and also to update the ticket status, communicate with other team members, and provide feedback or additional information related to the security issue; and wherein the developer view also provides information on individual training requirements to the developer, coding improvement over time with respect to writing secure code. Hence, the insight view offers a high-level overview of the organization's security status, the CTO view provides strategic insights for high-level technology executives, the Engineering Manager view provides a granular view for team leads, and the developer view caters to individual developers' needs for working on and resolving assigned security issues. So, each view is customized to serve the specific requirements of the respective stakeholders involved in the security issue resolution process within the vulnerability management platform.

According to one embodiment herein, the method for providing training requirements and assessing the effectiveness of the training is provided. The method involves mapping vulnerabilities or security issues to a training category. Mapping the security issues to the training category involves mapping each of the security issues to a corresponding training category, to determine the type of training needed to address and prevent similar security issues in the future. Hence, when security vulnerabilities or findings are identified through the plurality of application security testing methodologies, such as SAST, DAST, or SCA, they are categorized based on the type of security issue they represent. For instance, issues related to SQL injection may be categorized under “Injection” in line with OWASP's categorization. OWASP refers to the Open Web Application Security Project, an international non-profit organization focused on improving the security of web applications and software. OWASP provides valuable resources, tools, and guidelines to help organizations and developers address and prevent common security vulnerabilities in web applications. The vulnerability management platform leverages these OWASP categories to map vulnerabilities or findings identified during the application security testing process to specific training categories. The CTO can view the top 3 training categories for a team, allowing them to prioritize training efforts and address the most critical security risks effectively. By focusing on OWASP categories, developers can receive targeted training to enhance their understanding of secure coding practices and improve the overall security of the software projects they work on. Furthermore, the method involves identifying individual training requirements. The individual training requirements are determined by the CTO for an individual developer. Also, the individual training provides an identified individual developer who modified the code and introduced a particular security vulnerability, the classification system pinpoints the type of training the individual developer needs, to write more secure code. Furthermore, the method involves evaluating the training effectiveness and recording the training provided along with progress. In addition, the method involves aggregating training effectiveness data. Aggregating training effectiveness data allows the vulnerability management platform to identify specific training areas or categories where improvements are needed at an individual and team level. By aggregating the training information and effectiveness data over a number of developers, the vulnerability management platform can derive insights into the overall effectiveness of the training program. Hence, the vulnerability management platform's training system ensures that the developers receive targeted training based on the security vulnerabilities they introduced and evaluates the effectiveness of the training program to continuously improve the security awareness and coding practices of the development team.

According to one embodiment herein, evaluating training effectiveness involves monitoring the developers who received training on specific security topics, and assessing the developer on subsequent code changes, if similar vulnerabilities are still introduced, or if improvements are observed post-training. By assessing the developer post-training and by measuring the type of security issues introduced by the same developer after training, and mapping the security issues to the training category the developer received, the vulnerability management platform identifies gaps in knowledge or assesses the effectiveness of the training provided.

According to one embodiment herein, the recording of the training provided and progress involves capturing training details including training date, type of training, and attendees. Further, the recording of the training events and progress also enables easy tracking of individual developers' progress over time, indicating how their coding practices have improved post-training.

According to one embodiment herein, the vulnerability management platform also provides an option of auto-suggest/assignment of the owner, while creating a ticket manually. The auto-suggestion of the owner of a ticket is performed when the ticket is created automatically through the runbook. Further, the auto-suggestion of the owner for the ticket created manually is based on the code analysis of which developer made the last change just before the vulnerability or security issue is introduced.

According to one embodiment herein, the method for auto suggest of the owner, while creating a ticket manually is provided. The method involves identifying the vulnerability or security issue by the vulnerability management platform, when a user creates a new ticket to address the security issues. The ticket created comprises the information about the nature of the issue, including a description of the problem and possibly the exact line number or code section where the vulnerability or the security issues is found. The method further involves analyzing the code history to trace the changes made to the affected code section over time. The analysis of the code history involves identifying the last developer or team member who made a code change to the specific line number or code section just before the vulnerability dependency or the security issue is introduced. The method further involves suggesting the developer as a potential assignee, who made the last code change before the vulnerability is introduced to the ticket. In addition, the method involves reviewing the suggested potential assignee and deciding whether to accept auto-suggestion or manual adjustments by the user who created the ticket. Particularly, the auto-suggest feature offers the last developer as the initial recommendation and also provides the user the flexibility to override the auto-suggestion and manually assign the ticket to a different developer. Therefore, by utilizing the code analysis of who made the last changes just before the vulnerability was introduced, the auto-suggest option ensures that the ticket is automatically assigned to the developer most closely associated with the code section that needs attention. Hence, this approach can streamline the process of assigning security issues, improve accountability, and enhance the efficiency of resolving security vulnerabilities, as the developer who made the recent code change is likely to have valuable insights into the context and potential fixes for the issue.

According to one embodiment herein, a computer-implemented system for developer identification and ticket assignment is provided. The system comprises an application security testing module configured to apply an owner identification logic through a plurality of application security testing methodologies. The plurality of application security testing methodologies comprises Static Application Security Testing (SAST), Dynamic Application Security Testing (DAST), and Software Composition Analysis (SCA) tool. The system further comprises a vulnerability management module configured to make an Application Programming Interface (API) call through a vulnerability management platform, to a code repository, where a codebase is stored, to identify the changes made by a developer to the code recently. The system further comprises a ticketing management module configured to assign a ticket to the identified developer and saving a developer information in the vulnerability management platform of the vulnerability management module, and to view the status of the ticket through a plurality of views. The plurality of views comprises an insight view, a CTO view, an engineering manager view, and a developer view. The system further comprises a training module configured to provide training requirements and assess the effectiveness of the training provided.

According to one embodiment herein, the owner identification logic applied by the application security testing module involves utilizing data from the plurality of application security testing methodologies in conjunction with the information obtained from the code repository to identify an exact line number of a code, where a security issue is found or vulnerability dependency is defined. The combined results of SAST, DAST, and SCA testing provide information about potential security issues in the codebase. Therefore, the method determines the exact line number in the source code where each security issue is found or where the vulnerable dependency is defined. In addition, the SAST application security testing methodology is configured to identify vulnerability dependency on an exact line number of the code. The DAST application security testing methodology is configured to identify vulnerability dependency on the codebase and file or line of code, and using the line of code and the API call to identify the developer who committed the code using the line of code. The SCA tool is configured to identify the vulnerability dependency and license issues in an open source and software libraries, or components included in the codebase.

According to one embodiment herein, the Application Programming Interface (API) call made through the vulnerability management platform embedded in the vulnerability management module retrieves the information about the recent changes made to the codebase of the code repository (e.g., GitHub, GitLab, etc.) and also identifies which developer has made changes to the portion of the codebase where the security issue is found or the vulnerability dependency is defined.

According to one embodiment herein, the ticket assigned to the identified developer by the ticketing management module is updated in a tracking system, such as JIRA, or ServiceNow to track the security issue and its resolution. The security issue is assigned to the identified developer for further investigation and resolution. Hence, the security issues in the codebase can be efficiently addressed and assigned to the relevant developers, streamlining the process of remediation and ensuring a secure and reliable application.

According to one embodiment herein. if the identified developer is registered on the vulnerability management platform embedded in the vulnerability management module, the ticket is directly assigned to the identified developer, and if the identified developer is not registered on the vulnerability management platform, an email address is used for the ticket assignment and identification.

According to one embodiment herein, the developer information includes the developer who last amended the code or file or code repository. If the developer information is not available on the vulnerability management platform, then an engineering owner of a product or security owner, or business owner as configured during product creation is assigned the ticket, and in default, a default assignee or the developer as configured in a rulebook is also assigned with the ticket. A rulebook is a set of rules that define how the software should behave in certain situations. It is a way of defining the logic of an application in a structured way. Rulebooks are used in many different types of software applications, including business applications, games, and web applications.

According to one embodiment herein, the plurality of views to view the status of the ticket assigned by the ticketing management module are interfaces or different perspectives within the vulnerability management platform, that cater to specific stakeholders involved in the security issue resolution process, and each of the plurality of views provides relevant information and functionalities tailored to the needs of the respective role.

According to one embodiment herein, the insight view is a high-level overview or dashboard within the vulnerability management platform that provides a comprehensive summary of the overall security posture of the codebase. The insight view is configured to provide findings by the developers, for creating one ticket for multiple findings and assigning to the developer directly. In addition, the insight view is typically designed for executives, security leaders, or other high-level stakeholders who need a quick and easily digestible snapshot of the security status of the organization's software projects. The insight view include metrics, charts, and graphs to represent the number of open security issues, their severity, trends over time, and other key security-related data. Furthermore, the insight view enables decision-makers to assess the overall security health of the software projects and take appropriate actions or allocate resources as needed.

According to one embodiment herein, the Chief Technology Officer (CTO) view is a specific interface within the vulnerability management platform tailored for the CTO or other high-level technology executives, and the CTO view is configured to provide individual teams' performance information including the teams that are doing an excellent job of writing secure code and the teams that are not performing well. Further, the CTO view also provides a more detailed and strategic perspective compared to the insight view, focusing on the security status and progress of various projects and teams under the CTO's purview. In addition, the CTO view also offers aggregated metrics for multiple projects, allowing the CTO to evaluate the organization's security initiatives, identify potential areas of concern, and make strategic decisions related to security investments, team training, and project priorities.

According to one embodiment herein, the Engineering Manager view is configured to provide the engineering manager with the team's performance at a developer level. The Engineering Manager view also provides a more granular and operational level of information related to security issues and tickets assigned to their teams. The Engineering manager view is used by the Engineering managers to track the progress of security issue resolutions, monitor the workload and performance of their team members, and ensure that security priorities align with project timelines.

According to one embodiment herein, the developer view is a user interface specifically tailored for individual developers who are assigned tickets to address the security issues. The developer view also provides details of the security issues assigned to them, including the exact line number of the code where the security issue is found, along with any supporting information from the plurality of application security testing methodologies. The developers use the developer view to access the necessary information to understand the security issue, review any relevant testing results, work on resolving the issue in the codebase; and also to update the ticket status, communicate with other team members, and provide feedback or additional information related to the security issue; and wherein the developer view also provides information on individual training requirements to the developer, coding improvement over time with respect to writing secure code. Hence, the insight view offers a high-level overview of the organization's security status, the CTO view provides strategic insights for high-level technology executives, the Engineering Manager view provides a granular view for team leads, and the developer view caters to individual developers' needs for working on and resolving assigned security issues. So, each view is customized to serve the specific requirements of the respective stakeholders involved in the security issue resolution process within the vulnerability management platform.

According to one embodiment herein, the method for providing training requirements and assessing the effectiveness of the training by the training module is provided. The method involves mapping vulnerabilities or security issues to a training category. Mapping the security issues to the training category involves mapping each of the security issues to a corresponding training category, to determine the type of training needed to address and prevent similar security issues in the future. Hence, when security vulnerabilities or findings are identified through the plurality of application security testing methodologies, such as SAST, DAST, or SCA, they are categorized based on the type of security issue they represent. For instance, issues related to SQL injection may be categorized under “Injection” in line with OWASP's categorization. OWASP refers to the Open Web Application Security Project, an international non-profit organization focused on improving the security of web applications and software. OWASP provides valuable resources, tools, and guidelines to help organizations and developers address and prevent common security vulnerabilities in web applications. The vulnerability management platform leverages these OWASP categories to map vulnerabilities or findings identified during the application security testing process to specific training categories. The CTO can view the top 3 training categories for a team, allowing them to prioritize training efforts and address the most critical security risks effectively. By focusing on OWASP categories, developers can receive targeted training to enhance their understanding of secure coding practices and improve the overall security of the software projects they work on. Furthermore, the method involves identifying individual training requirements. The individual training requirements are determined by the CTO for an individual developer. Also, the individual training provides an identified individual developer who modified the code and introduced a particular security vulnerability, the classification system pinpoints the type of training the individual developer needs, to write more secure code. Furthermore, the method involves evaluating the training effectiveness and recording the training provided along with progress. In addition, the method involves aggregating training effectiveness data. The aggregation of training effectiveness data allows the vulnerability management platform to identify specific training areas or categories where improvements are needed at both an individual and team level. By aggregating the training information and effectiveness data over a number of developers, the vulnerability management platform can derive insights into the overall effectiveness of the training program. Hence, the vulnerability management platform's training system ensures that the developers receive targeted training based on the security vulnerabilities they introduced and evaluates the effectiveness of the training program to continuously improve the security awareness and coding practices of the development team.

According to one embodiment herein, evaluating training effectiveness by the training module involves monitoring the developers who received training on specific security topics, and assessing the developer on subsequent code changes, if similar vulnerabilities are still introduced, or if improvements are observed post-training. By assessing the developer post-training and by measuring the type of security issues introduced by the same developer after training, and mapping the security issues to the training category the developer received, the vulnerability management platform identifies gaps in knowledge or assesses the effectiveness of the training provided.

According to one embodiment herein, the recording of the training provided and progress involves capturing training details including training date, type of training, and attendees. Further, the recording of the training events and progress also enables easy tracking of individual developers' progress over time, indicating how their coding practices have improved post-training.

According to one embodiment herein, the vulnerability management platform embedded in the vulnerability management module also provides an option of auto-suggest/assignment of the owner, while creating a ticket manually. The auto-suggestion of the owner of a ticket is performed when the ticket is created automatically through the runbook. Further, the auto-suggestion of the owner for the ticket created manually is based on the code analysis of which developer made the last change just before the vulnerability or security issue is introduced.

According to one embodiment herein, the method for auto suggest of owner provided by the vulnerability management module while creating a ticket manually is provided. The method involves identifying the vulnerability or security issue by the vulnerability management platform, when a user creates a new ticket to address the security issues. The ticket created comprises the information about the nature of the issue, including a description of the problem and possibly the exact line number or code section where the vulnerability or the security issues is found. The method further involves analyzing the code history to trace the changes made to the affected code section over time. The analysis of the code history involves identifying the last developer or team member who made a code change to the specific line number or code section just before the vulnerability dependency or the security issue is introduced. The method further involves suggesting the developer as a potential assignee, who made the last code change before the vulnerability is introduced to the ticket. In addition, the method involves reviewing the suggested potential assignee and deciding whether to accept auto-suggestion or manual adjustments by the user who created the ticket. Particularly, the auto-suggest feature offers the last developer as the initial recommendation and also provides the user the flexibility to override the auto-suggestion and manually assign the ticket to a different developer. Therefore, by utilizing the code analysis of who made the last changes just before the vulnerability was introduced, the auto-suggest option ensures that the ticket is automatically assigned to the developer most closely associated with the code section that needs attention. Hence, this approach can streamline the process of assigning security issues, improve accountability, and enhance the efficiency of resolving security vulnerabilities, as the developer who made the recent code change is likely to have valuable insights into the context and potential fixes for the issue.

The foregoing summary is illustrative only and is not intended to be in any way limiting. In addition to the illustrative aspects, embodiments, and features described above, further aspects, embodiments, and features will become apparent by reference to the drawings and the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flowchart depicting a method for developer identification and ticket assignment, according to one embodiment herein.

FIG. 2 depicts a computer-implemented system for developer identification and ticket assignment is provided, according to one embodiment herein.

FIG. 3 illustrates a screenshot of developer information in the vulnerability management platform, in accordance with an embodiment herein.

FIG. 4 illustrates a screenshot of Insight view, in accordance with an embodiment herein.

FIG. 5 illustrates a screenshot of a Runbook, in accordance with an embodiment herein.

FIG. 6 illustrates a screenshot of manual ticket creation from findings, in accordance with an embodiment herein.

FIG. 7 illustrates a screenshot of threats incurred by a Team, in accordance with an embodiment herein.

FIG. 8 illustrates a screenshot of team training requirements, in accordance with an embodiment herein.

Although the specific features of the present invention are shown in some drawings and not in others. This is done for convenience only as each feature may be combined with any or all of the other features in accordance with the present invention.

### DETAILED DESCRIPTION OF THE EMBODIMENTS HEREIN

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical, and other changes may be made without departing from the scope of the embodiments. The following detailed description is therefore not to be taken in a limiting sense.

The foregoing of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The various embodiments herein provide a computer-implemented method and system for developer identification and ticket assignment. The method for developed identification and ticket assignment is provided. The method comprises applying an owner identification logic through a plurality of application security testing methodologies. The plurality of application security testing methodologies comprises Static Application Security Testing (SAST), Dynamic Application Security Testing (DAST), and Software Composition Analysis (SCA) tool. The method further comprises making an Application Programming Interface (API) call through a vulnerability management platform, to a code repository (GitHub, Gitlab etc.,), where a codebase is stored, to identify the changes made by a developer to the code recently. In addition, the method comprises assigning a ticket to the identified developer and saving a developer's information in the vulnerability management platform. Furthermore, the method comprises viewing the status of the ticket through a plurality of views. The plurality of views comprises an insight view, a CTO view, an engineering manager view, and a developer view. Further, the method comprises providing training requirements and assessing the effectiveness of the training provided.

According to one embodiment herein, the owner identification logic involves utilizing data from the plurality of application security testing methodologies in conjunction with the information obtained from the code repository to identify an exact line number of a code, where a security issue is found or vulnerability dependency is defined. The combined results of SAST, DAST, and SCA testing provide information about potential security issues in the codebase. Therefore, the method determines the exact line number in the source code where each security issue is found or where the vulnerable dependency is defined. In addition, the SAST application security testing methodology is configured to identify vulnerability dependency on an exact line number of the code. The DAST application security testing methodology is configured to identify vulnerability dependency on the codebase and file or line of code, and using the line of code and the API call to identify the developer who committed the code using the line of code. The SCA tool is configured to identify the vulnerability dependency and license issues in an open source and software libraries, or components included in the codebase.

According to one embodiment herein, the Application Programming Interface (API) call made through the vulnerability management platform retrieves the information about the recent changes made to the codebase of the code repository (e.g., GitHub, GitLab, etc.) and also identifies which developer has made changes to the portion of the codebase where the security issue or the vulnerability dependency is found.

According to one embodiment herein, the ticket assigned to the identified developer is updated in a tracking system, such as JIRA, or ServiceNow to track the security issue and its resolution. The security issue is assigned to the identified developer for further investigation and resolution. Hence, the security issues in the codebase can be efficiently addressed and assigned to the relevant developers, streamlining the process of remediation and ensuring a secure and reliable application.

According to one embodiment herein, if the identified developer is registered on the vulnerability management platform, the ticket is directly assigned to the identified developer, and if the identified developer is not registered on the vulnerability management platform, an email address is used for the ticket assignment and identification.

According to one embodiment herein, the developer information includes the developer who last amended the code or file or code repository. If the developer information is not available on the vulnerability management platform, then an engineering owner of a product or security owner, or business owner as configured during product creation is assigned the ticket, and in default, a default assignee or the developer as configured in a rulebook is also assigned with the ticket. A rulebook is a set of rules that define how the software should behave in certain situations. It is a way of defining the logic of an application in a structured way. Rulebooks are used in many different types of software applications, including business applications, games, and web applications.

According to one embodiment herein, the plurality of views are interfaces or different perspectives within the vulnerability management platform, that cater to specific stakeholders involved in the security issue resolution process, and each of the plurality of views provides relevant information and functionalities tailored to the needs of the respective role.

According to one embodiment herein, the insight view is a high-level overview or dashboard within the vulnerability management platform that provides a comprehensive summary of the overall security posture of the codebase. The insight view is configured to provide findings by the developers, for creating one ticket for multiple findings and assigning to the developer directly. In addition, the insight view is typically designed for executives, security leaders, or other high-level stakeholders who need a quick and easily digestible snapshot of the security status of the organization's software projects. The insight view include metrics, charts, and graphs to represent the number of open security issues, their severity, trends over time, and other key security-related data. Furthermore, the insight view enables decision-makers to assess the overall security health of the software projects and take appropriate actions or allocate resources as needed.

According to one embodiment herein, the Chief Technology Officer (CTO) view is a specific interface within the vulnerability management platform tailored for the CTO or other high-level technology executives, and the CTO view is configured to provide individual teams' performance information including the teams that are doing an excellent job of writing secure code and the teams that are not performing well. Further, the CTO view also provides a more detailed and strategic perspective compared to the insight view, focusing on the security status and progress of various projects and teams under the CTO's purview. In addition, the CTO view also offers aggregated metrics for multiple projects, allowing the CTO to evaluate the organization's security initiatives, identify potential areas of concern, and make strategic decisions related to security investments, team training, and project priorities.

According to one embodiment herein, the Engineering Manager view is configured to provide the engineering manager with the team's performance at a developer level. The Engineering Manager view also provides a more granular and operational level of information related to security issues and tickets assigned to their teams. The Engineering manager view is used by the Engineering managers to track the progress of security issue resolutions, monitor the workload and performance of their team members, and ensure that security priorities align with project timelines.

According to one embodiment herein, the developer view is a user interface specifically tailored for individual developers who are assigned tickets to address the security issues. The developer view also provides details of the security issues assigned to them, including the exact line number of the code where the security issue is found, along with any supporting information from the plurality of application security testing methodologies. The developers use the developer view to access the necessary information to understand the security issue, review any relevant testing results, work on resolving the issue in the codebase; and also to update the ticket status, communicate with other team members, and provide feedback or additional information related to the security issue; and wherein the developer view also provides information on individual training requirements to the developer, coding improvement over time with respect to writing secure code. Hence, the insight view offers a high-level overview of the organization's security status, the CTO view provides strategic insights for high-level technology executives, the Engineering Manager view provides a granular view for team leads, and the developer view caters to individual developers' needs for working on and resolving assigned security issues. So, each view is customized to serve the specific requirements of the respective stakeholders involved in the security issue resolution process within the vulnerability management platform.

According to one embodiment herein, the method for providing training requirements and assessing the effectiveness of the training is provided. The method involves mapping vulnerabilities or security issues to a training category. Mapping the security issues to the training category involves mapping each of the security issues to a corresponding training category, to determine the type of training needed to address and prevent similar security issues in the future. Hence, when security vulnerabilities or findings are identified through the plurality of application security testing methodologies, such as SAST, DAST, or SCA, they are categorized based on the type of security issue they represent. For instance, issues related to SQL injection may be categorized under “Injection” in line with OWASP's categorization. OWASP refers to the Open Web Application Security Project, an international non-profit organization focused on improving the security of web applications and software. OWASP provides valuable resources, tools, and guidelines to help organizations and developers address and prevent common security vulnerabilities in web applications. The vulnerability management platform leverages these OWASP categories to map vulnerabilities or findings identified during the application security testing process to specific training categories. The CTO can view the top 3 training categories for a team, allowing them to prioritize training efforts and address the most critical security risks effectively. By focusing on OWASP categories, developers can receive targeted training to enhance their understanding of secure coding practices and improve the overall security of the software projects they work on. Furthermore, the method involves identifying individual training requirements. The individual training requirements are determined by the CTO for an individual developer. Also, the individual training provides an identified individual developer who modified the code and introduced a particular security vulnerability, the classification system pinpoints the type of training the individual developer needs, to write more secure code. Furthermore, the method involves evaluating the training effectiveness and recording the training provided along with progress. In addition, the method involves aggregating training effectiveness data. The aggregation of training effectiveness data allows the vulnerability management platform to identify specific training areas or categories where improvements are needed at both an individual and team level. By aggregating the training information and effectiveness data over a number of developers, the vulnerability management platform can derive insights into the overall effectiveness of the training program. Hence, the vulnerability management platform's training system ensures that the developers receive targeted training based on the security vulnerabilities they introduced and evaluates the effectiveness of the training program to continuously improve the security awareness and coding practices of the development team.

Furthermore, some potential training requirements include secure coding best practices: training on general secure coding best practices, including input validation, output encoding, secure authentication, and secure error handling; OWASP top ten training: training focused on the OWASP top ten, which represents the most critical web application security risks. This training may include topics like SQL injection, cross-site scripting (XSS), security misconfigurations, etc; Secure authentication and authorization: Training on implementing secure authentication and authorization mechanisms to protect user accounts and access control; data privacy and protection: Training related to handling sensitive data securely, including encryption, data masking, and data anonymization techniques; API security: Training on securing APIs to prevent attacks like injection, broken authentication, and excessive data exposure; Secure use of libraries and frameworks: Training developers on using third-party libraries and frameworks securely, ensuring that they are up-to-date and free from known vulnerabilities; Threat modeling and risk assessment: Training on threat modeling techniques to identify potential security risks early in the development process; and Secure code reviews: Training developers on how to conduct secure code reviews, ensuring that code changes are thoroughly examined for security vulnerabilities.

According to one embodiment herein, evaluating training effectiveness involves monitoring the developers who received training on specific security topics, and assessing the developer on subsequent code changes, if similar vulnerabilities are still introduced, or if improvements are observed post-training. By assessing the developer post-training and by measuring the type of security issues introduced by the same developer after training, and mapping the security issues to the training category the developer received, the vulnerability management platform identifies gaps in knowledge or assesses the effectiveness of the training provided.

According to one embodiment herein, the recording of the training provided and progress involves capturing training details including training date, type of training, and attendees. Further, the recording of the training events and progress also enables easy tracking of individual developers' progress over time, indicating how their coding practices have improved post-training.

According to one embodiment herein, the vulnerability management platform also provides an option of auto-suggest/assignment of the owner, while creating a ticket manually. The auto-suggestion of the owner of a ticket is performed when the ticket is created automatically through the runbook. Further, the auto-suggestion of the owner for the ticket created manually is based on the code analysis of which developer made the last change just before the vulnerability or security issue is introduced.

According to one embodiment herein, the method for auto suggest of owner, while creating a ticket manually is provided. The method involves identifying the vulnerability or security issue by the vulnerability management platform, when a user creates a new ticket to address the security issues. The ticket created comprises the information about the nature of the issue, including a description of the problem and possibly the exact line number or code section where the vulnerability or the security issues is found. The method further involves analyzing the code history to trace the changes made to the affected code section over time. The analysis of the code history involves identifying the last developer or team member who made a code change to the specific line number or code section just before the vulnerability dependency or the security issue is introduced. The method further involves suggesting the developer as a potential assignee, who made the last code change before the vulnerability is introduced to the ticket. In addition, the method involves reviewing the suggested potential assignee and deciding whether to accept auto-suggestion or manual adjustments by the user who created the ticket. Particularly, the auto-suggest feature offers the last developer as the initial recommendation and also provides the user the flexibility to override the auto-suggestion and manually assign the ticket to a different developer. Therefore, by utilizing the code analysis of who made the last changes just before the vulnerability was introduced, the auto-suggest option ensures that the ticket is automatically assigned to the developer most closely associated with the code section that needs attention. Hence, this approach can streamline the process of assigning security issues, improve accountability, and enhance the efficiency of resolving security vulnerabilities, as the developer who made the recent code change is likely to have valuable insights into the context and potential fixes for the issue.

According to one embodiment herein, a computer-implemented system for developer identification and ticket assignment is provided. The system comprises an application security testing module configured to apply an owner identification logic through a plurality of application security testing methodologies. The plurality of application security testing methodologies comprises Static Application Security Testing (SAST), Dynamic Application Security Testing (DAST), and Software Composition Analysis (SCA) tool. The system further comprises a vulnerability management module configured to make an Application Programming Interface (API) call through a vulnerability management platform, to a code repository, where a codebase is stored, to identify the changes made by a developer to the code recently. The system further comprises a ticketing management module configured to assign a ticket to the identified developer and saving a developer information in the vulnerability management platform of the vulnerability management module, and to view the status of the ticket through a plurality of views. The plurality of views comprises an insight view, a CTO view, an engineering manager view, and a developer view. The system further comprises a training module configured to provide training requirements and assess the effectiveness of the training provided.

According to one embodiment herein, the owner identification logic applied by the application security testing module involves utilizing data from the plurality of application security testing methodologies in conjunction with the information obtained from the code repository to identify an exact line number of a code, where a security issue is found or vulnerability dependency is defined. The combined results of SAST, DAST, and SCA testing provide information about potential security issues in the codebase. Therefore, the method determines the exact line number in the source code where each security issue is found or where the vulnerable dependency is defined. In addition, the SAST application security testing methodology is configured to identify vulnerability dependency on an exact line number of the code. The DAST application security testing methodology is configured to identify vulnerability dependency on the codebase and file or line of code, and using the line of code and the API call to identify the developer who committed the code using the line of code. The SCA tool is configured to identify the vulnerability dependency and license issues in an open source and software libraries, or components included in the codebase.

According to one embodiment herein, the Application Programming Interface (API) call made through the vulnerability management platform embedded in the vulnerability management module retrieves the information about the recent changes made to the codebase of the code repository (e.g., GitHub, GitLab, etc.) and also identifies which developer has made changes to the portion of the codebase where the security issue is found or the vulnerability dependency is defined.

According to one embodiment herein, the ticket assigned to the identified developer by the ticketing management module is updated in a tracking system, such as JIRA, or ServiceNow to track the security issue and its resolution. The security issue is assigned to the identified developer for further investigation and resolution. Hence, the security issues in the codebase can be efficiently addressed and assigned to the relevant developers, streamlining the process of remediation and ensuring a secure and reliable application.

According to one embodiment herein, if the identified developer is registered on the vulnerability management platform embedded in the vulnerability management module, the ticket is directly assigned to the identified developer, and if the identified developer is not registered on the vulnerability management platform, an email address is used for the ticket assignment and identification.

According to one embodiment herein, the developer information includes the developer who last amended the code or file or code repository. If the developer information is not available on the vulnerability management platform, then an engineering owner of a product or security owner, or business owner as configured during product creation is assigned the ticket, and in default, a default assignee or the developer as configured in a rulebook is also assigned with the ticket. A rulebook is a set of rules that define how the software should behave in certain situations. It is a way of defining the logic of an application in a structured way. Rulebooks are used in many different types of software applications, including business applications, games, and web applications.

According to one embodiment herein, the plurality of views to view the status of the ticket assigned by the ticketing management module are interfaces or different perspectives within the vulnerability management platform, that cater to specific stakeholders involved in the security issue resolution process, and each of the plurality of views provides relevant information and functionalities tailored to the needs of the respective role.

According to one embodiment herein, the insight view is a high-level overview or dashboard within the vulnerability management platform that provides a comprehensive summary of the overall security posture of the codebase. The insight view is configured to provide findings by the developers, for creating one ticket for multiple findings and assigning to the developer directly. In addition, the insight view is typically designed for executives, security leaders, or other high-level stakeholders who need a quick and easily digestible snapshot of the security status of the organization's software projects. The insight view include metrics, charts, and graphs to represent the number of open security issues, their severity, trends over time, and other key security-related data. Furthermore, the insight view enables decision-makers to assess the overall security health of the software projects and take appropriate actions or allocate resources as needed.

According to one embodiment herein, the Chief Technology Officer (CTO) view is a specific interface within the vulnerability management platform tailored for the CTO or other high-level technology executives, and the CTO view is configured to provide individual teams' performance information including the teams that are doing an excellent job of writing secure code and the teams that are not performing well. Further, the CTO view also provides a more detailed and strategic perspective compared to the insight view, focusing on the security status and progress of various projects and teams under the CTO's purview. In addition, the CTO view also offers aggregated metrics for multiple projects, allowing the CTO to evaluate the organization's security initiatives, identify potential areas of concern, and make strategic decisions related to security investments, team training, and project priorities.

According to one embodiment herein, the Engineering Manager view is configured to provide the engineering manager, with the team's performance at a developer level. The Engineering Manager view also provides a more granular and operational level of information related to security issues and tickets assigned to their teams. The Engineering manager view is used by the Engineering managers to track the progress of security issue resolutions, monitor the workload and performance of their team members, and ensure that security priorities align with project timelines.

According to one embodiment herein, the developer view is a user interface specifically tailored for individual developers who are assigned tickets to address the security issues. The developer view also provides details of the security issues assigned to them, including the exact line number of the code where the security issue is found, along with any supporting information from the plurality of application security testing methodologies. The developers use the developer view to access the necessary information to understand the security issue, review any relevant testing results, work on resolving the issue in the codebase; and also to update the ticket status, communicate with other team members, and provide feedback or additional information related to the security issue; and wherein the developer view also provides information on individual training requirements to the developer, coding improvement over time with respect to writing secure code. Hence, the insight view offers a high-level overview of the organization's security status, the CTO view provides strategic insights for high-level technology executives, the Engineering Manager view provides a granular view for team leads, and the developer view caters to individual developers' needs for working on and resolving assigned security issues. So, each view is customized to serve the specific requirements of the respective stakeholders involved in the security issue resolution process within the vulnerability management platform.

According to one embodiment herein, the method for providing training requirements and assessing the effectiveness of the training by the training module is provided. The method involves mapping vulnerabilities or security issues to a training category. Mapping the security issues to the training category involves mapping each of the security issues to a corresponding training category, to determine the type of training needed to address and prevent similar security issues in the future. Hence, when security vulnerabilities or findings are identified through the plurality of application security testing methodologies, such as SAST, DAST, or SCA, they are categorized based on the type of security issue they represent. For instance, issues related to SQL injection may be categorized under “Injection” in line with OWASP's categorization. OWASP refers to the Open Web Application Security Project, an international non-profit organization focused on improving the security of web applications and software. OWASP provides valuable resources, tools, and guidelines to help organizations and developers address and prevent common security vulnerabilities in web applications. The vulnerability management platform leverages these OWASP categories to map vulnerabilities or findings identified during the application security testing process to specific training categories. The CTO can view the top 3 training categories for a team, allowing them to prioritize training efforts and address the most critical security risks effectively. By focusing on OWASP categories, developers can receive targeted training to enhance their understanding of secure coding practices and improve the overall security of the software projects they work on. Furthermore, the method involves identifying individual training requirements. The individual training requirements are determined by the CTO for an individual developer. Also, the individual training provides an identified individual developer who modified the code and introduced a particular security vulnerability, the classification system pinpoints the type of training the individual developer needs, to write more secure code. Furthermore, the method involves evaluating the training effectiveness and recording the training provided along with progress. In addition, the method involves aggregating training effectiveness data. The aggregation of training effectiveness data allows the vulnerability management platform to identify specific training areas or categories where improvements are needed at both an individual and team level. By aggregating the training information and effectiveness data over a number of developers, the vulnerability management platform can derive insights into the overall effectiveness of the training program. Hence, the vulnerability management platform's training system ensures that the developers receive targeted training based on the security vulnerabilities they introduced and evaluates the effectiveness of the training program to continuously improve the security awareness and coding practices of the development team.

Furthermore, some potential training requirements include secure coding best practices: training on general secure coding best practices, including input validation, output encoding, secure authentication, and secure error handling; OWASP top ten training: training focused on the OWASP top ten, which represents the most critical web application security risks. This training may include topics like SQL injection, cross-site scripting (XSS), security misconfigurations, etc; Secure authentication and authorization: Training on implementing secure authentication and authorization mechanisms to protect user accounts and access control; data privacy and protection: Training related to handling sensitive data securely, including encryption, data masking, and data anonymization techniques; API security: Training on securing APIs to prevent attacks like injection, broken authentication, and excessive data exposure; Secure use of libraries and frameworks: Training developers on using third-party libraries and frameworks securely, ensuring that they are up-to-date and free from known vulnerabilities; Threat modeling and risk assessment: Training on threat modeling techniques to identify potential security risks early in the development process; and Secure code reviews: Training developers on how to conduct secure code reviews, ensuring that code changes are thoroughly examined for security vulnerabilities.

According to one embodiment herein, evaluating training effectiveness by the training module involves monitoring the developers who received training on specific security topics, and assessing the developer on subsequent code changes, if similar vulnerabilities are still introduced, or if improvements are observed post-training. By assessing the developer post-training and by measuring the type of security issues introduced by the same developer after training, and mapping the security issues to the training category the developer received, the vulnerability management platform identifies gaps in knowledge or assesses the effectiveness of the training provided.

According to one embodiment herein, the recording of the training provided and progress involves capturing training details including training date, type of training, and attendees. Further, the recording of the training events and progress also enables easy tracking of individual developers' progress over time, indicating how their coding practices have improved post-training.

According to one embodiment herein, the vulnerability management platform embedded in the vulnerability management module also provides an option of auto-suggest/assignment of the owner, while creating a ticket manually. The auto-suggestion of the owner of a ticket is performed when the ticket is created automatically through the runbook. Further, the auto-suggestion of the owner for the ticket created manually is based on the code analysis of which developer made the last change just before the vulnerability or security issue is introduced.

According to one embodiment herein, the method for auto suggest of owner provided by the vulnerability management module while creating a ticket manually is provided. The method involves identifying the vulnerability or security issue by the vulnerability management platform, when a user creates a new ticket to address the security issues. The ticket created comprises the information about the nature of the issue, including a description of the problem and possibly the exact line number or code section where the vulnerability or the security issues is found. The method further involves analyzing the code history to trace the changes made to the affected code section over time. The analysis of the code history involves identifying the last developer or team member who made a code change to the specific line number or code section just before the vulnerability dependency or the security issue is introduced. The method further involves suggesting the developer as a potential assignee, who made the last code change before the vulnerability is introduced to the ticket. In addition, the method involves reviewing the suggested potential assignee and deciding whether to accept auto-suggestion or manual adjustments by the user who created the ticket. Particularly, the auto-suggest feature offers the last developer as the initial recommendation and also provides the user the flexibility to override the auto-suggestion and manually assign the ticket to a different developer. Therefore, by utilizing the code analysis of who made the last changes just before the vulnerability was introduced, the auto-suggest option ensures that the ticket is automatically assigned to the developer most closely associated with the code section that needs attention. Hence, this approach can streamline the process of assigning security issues, improve accountability, and enhance the efficiency of resolving security vulnerabilities, as the developer who made the recent code change is likely to have valuable insights into the context and potential fixes for the issue.

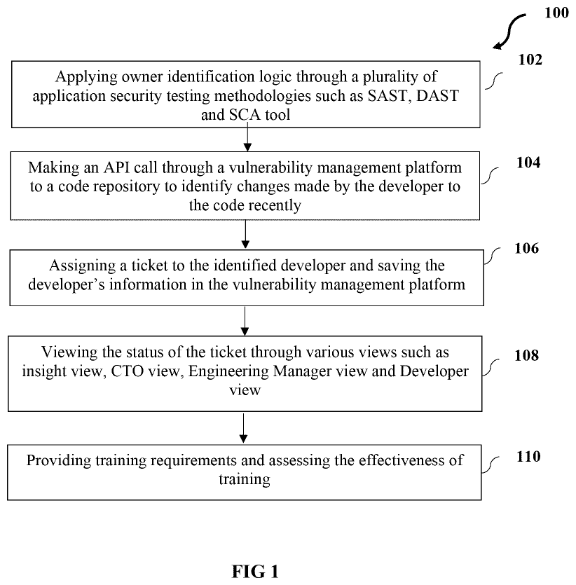

FIG. 1 illustrates a flowchart depicting a method for developer identification and ticket assignment, according to one embodiment herein. The method 100 comprises applying an owner identification logic through a plurality of application security testing methodologies at step 102. The plurality of application security testing methodologies comprises Static Application Security Testing (SAST), Dynamic Application Security Testing (DAST), and Software Composition Analysis (SCA) tool. The method 100 further comprises making an Application Programming Interface (API) call through a vulnerability management platform, to a code repository (GitHub, Gitlab etc.,), where a codebase is stored, to identify the changes made by a developer to the code recently at step 104. In addition, the method 100 comprises assigning a ticket to the identified developer and saving a developer's information in the vulnerability management platform at step 106. Furthermore, the method 100 comprises viewing the status of the ticket through a plurality of views at step 108. The plurality of views comprises an insight view, a CTO view, an engineering manager view, and a developer view. Further, the method 100 comprises providing training requirements and assessing the effectiveness of the training provided at step 110.

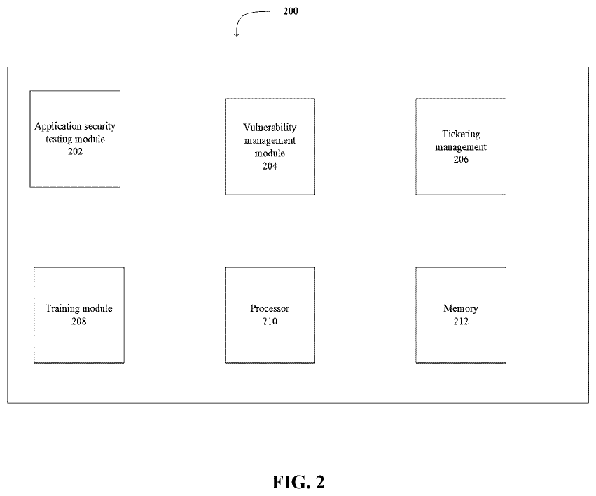

FIG. 2 depicts a computer-implemented system for developer identification and ticket assignment is provided, according to one embodiment herein. The system 200 comprises an application security testing module 202 configured to apply an owner identification logic through a plurality of application security testing methodologies. The plurality of application security testing methodologies comprises Static Application Security Testing (SAST), Dynamic Application Security Testing (DAST), and Software Composition Analysis (SCA) tool. The system 200 further comprises a vulnerability management module 204 configured to make an Application Programming Interface (API) call through a vulnerability management platform, to a code repository, where a codebase is stored, to identify the changes made by a developer to the code recently. The system 200 further comprises a ticketing management module 206 configured to assign a ticket to the identified developer and saving a developer information in the vulnerability management platform of the vulnerability management module 204, and to view the status of the ticket through a plurality of views. The plurality of views comprises an insight view, a CTO view, an engineering manager view, and a developer view. The system 200 further comprises a training module 208 configured to provide training requirements and assess the effectiveness of the training provided.

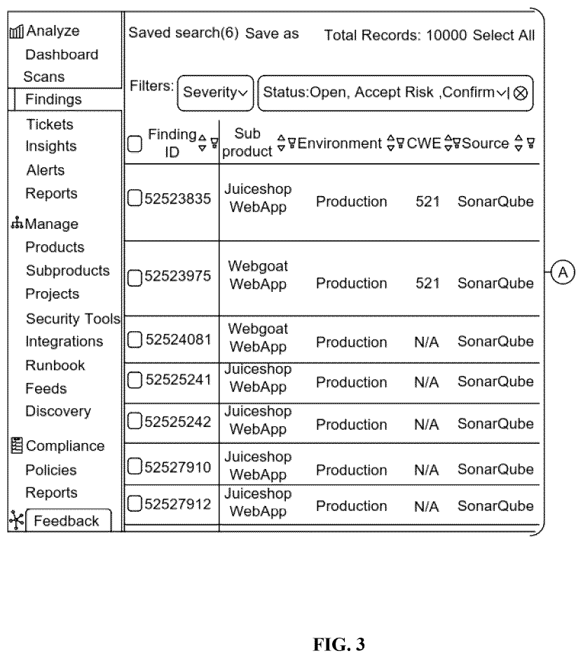

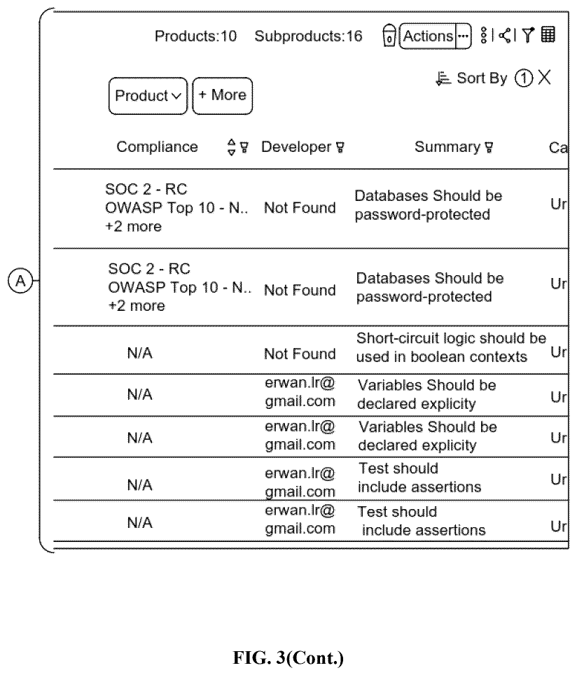

FIG. 3 illustrates a screenshot of developer information in the vulnerability management platform, in accordance with an embodiment herein. FIG. 3 illustrates a screenshot of developer information in the vulnerability management platform. For instance, in the FIG. 3 for the finding ID 52525241, subproduct Juiceshop WebApp, the developer information includes email id of the developer and the summary.

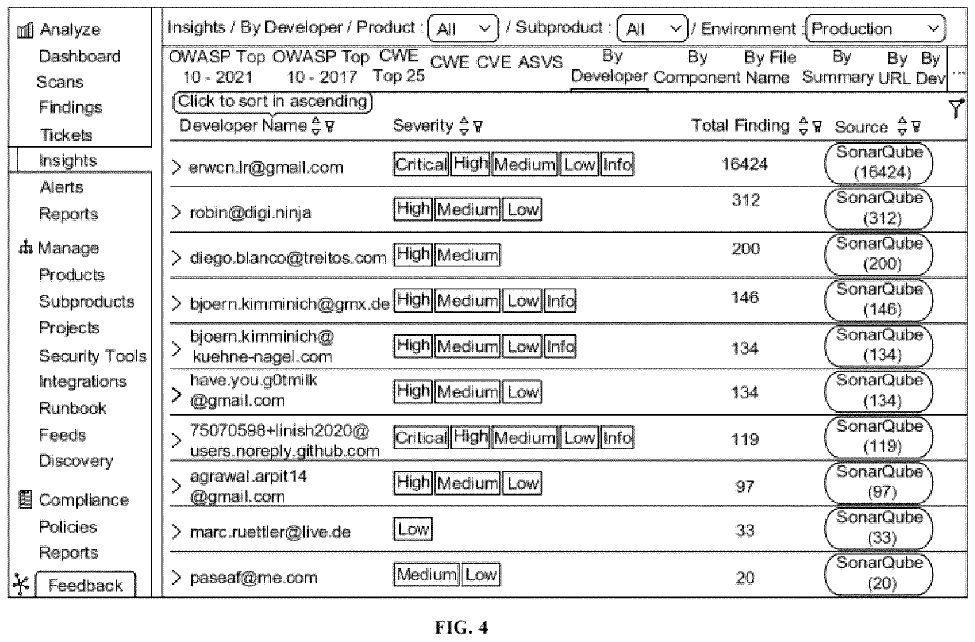

FIG. 4 illustrates a screenshot of Insight view, in accordance with an embodiment herein. FIG. 4 illustrates the Insight view comprising the developer's name, severity of the vulnerability, such as critical, high, medium, and low, and total findings.

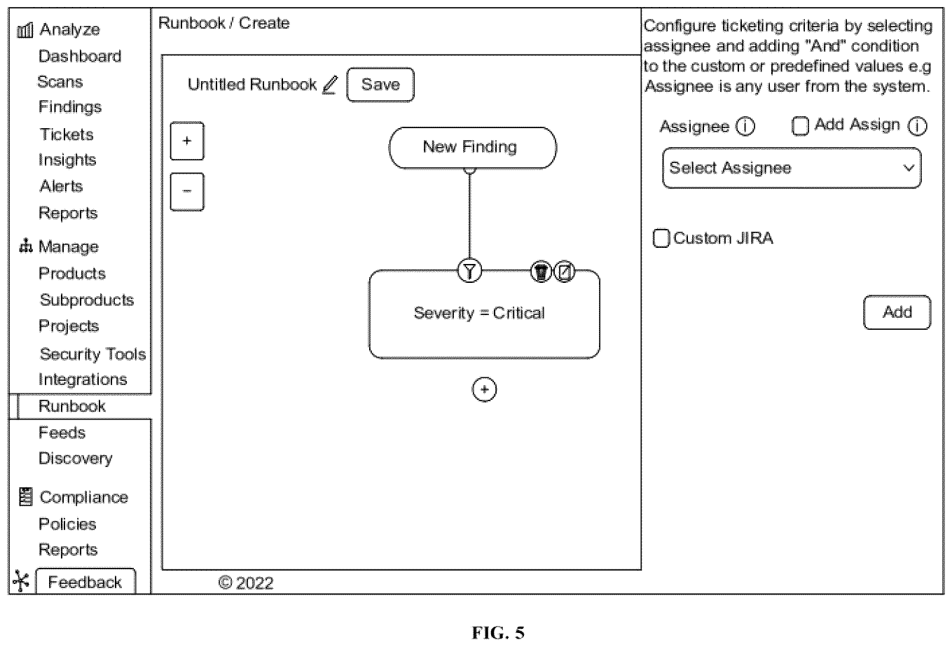

FIG. 5 illustrates a screenshot of a Runbook, in accordance with an embodiment herein. FIG. 5 illustrates a screenshot of a Runbook, which provides the details about the ticket assignment and the severity of the ticket such as critical, high, medium, or low.

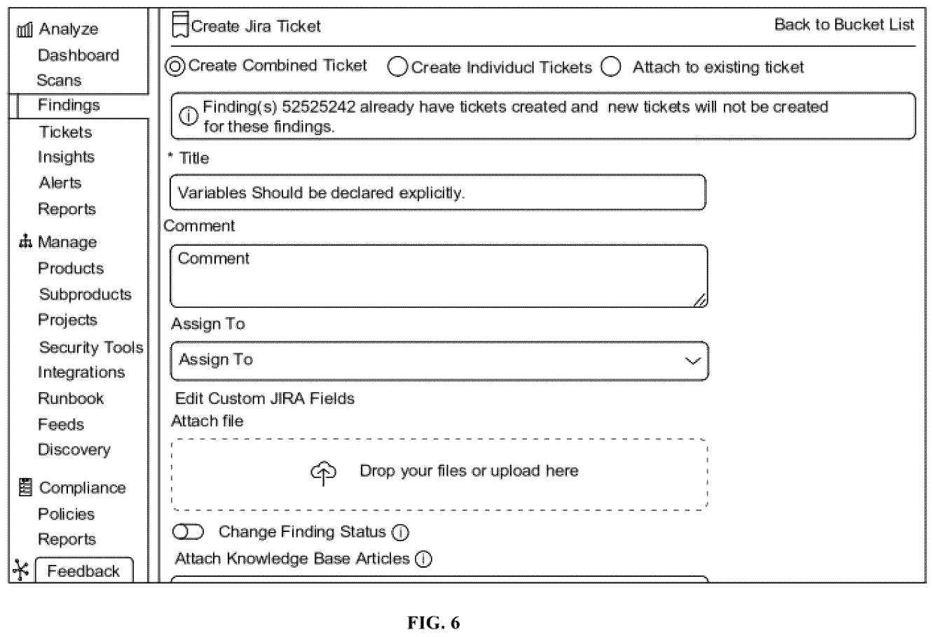

FIG. 6 illustrates a screenshot of manual ticket creation from findings, in accordance with an embodiment herein. The FIG. 6 illustrates a screenshot of creating tickets manually using various options such as create combined ticket, create individual ticket, or attach to existing ticket. While creating a ticket, the vulnerability management platform also provides an option to attach a knowledge base article with respect to the ticket assigned to a developer.

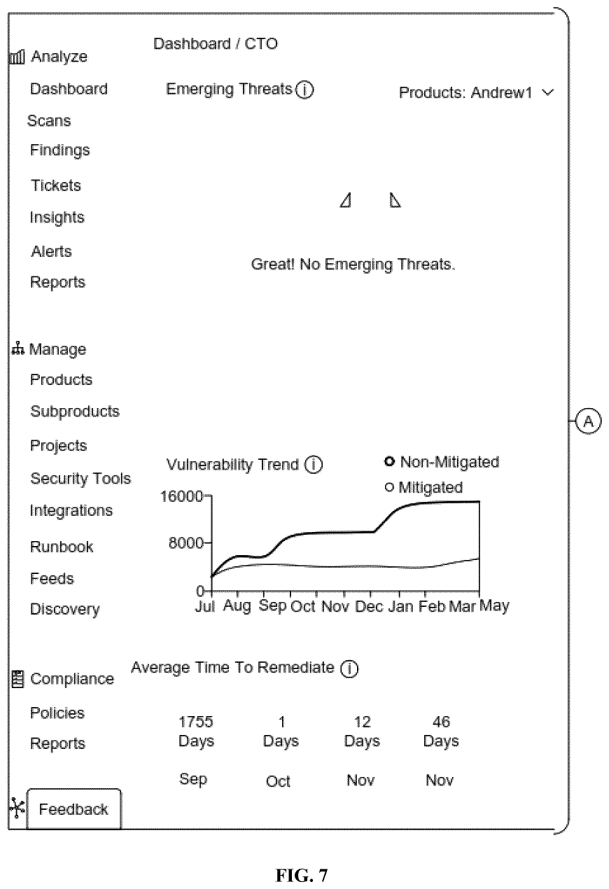

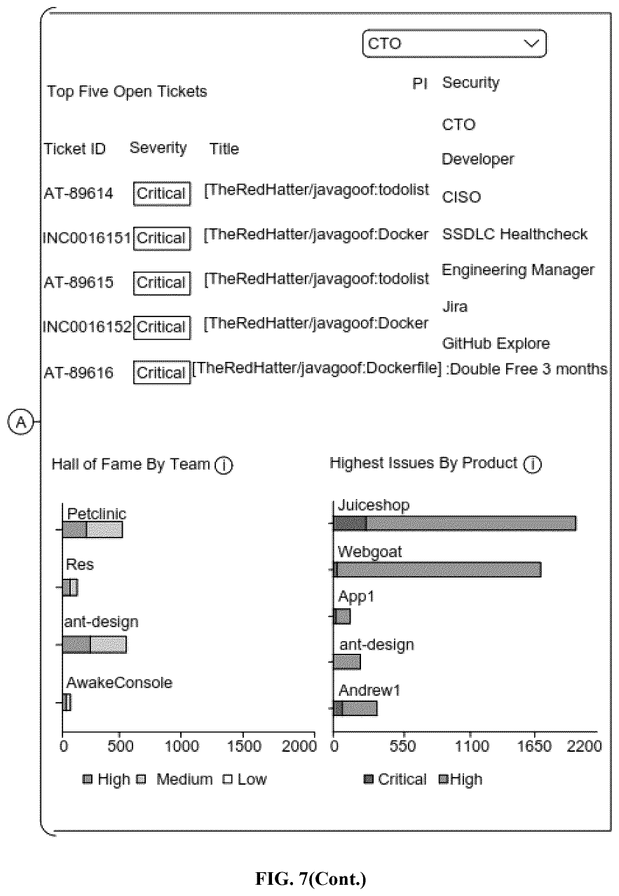

FIG. 7 illustrates a screenshot of threats incurred by a Team, in accordance with an embodiment herein. The FIG. 7 illustrates a CTO view configured to provide individual teams' performance including which teams are doing an excellent job of writing secure code and which teams are not doing an excellent job. Furthermore, a drill down of teams based on individual performance is also possible. FIG. 7 also provides a lookup menu including developer view, security view, engineering manager view, etc. The CTO view provides emerging threats, Top five open tickets, vulnerability trends, hall of fame by a team, and highest issues by product.

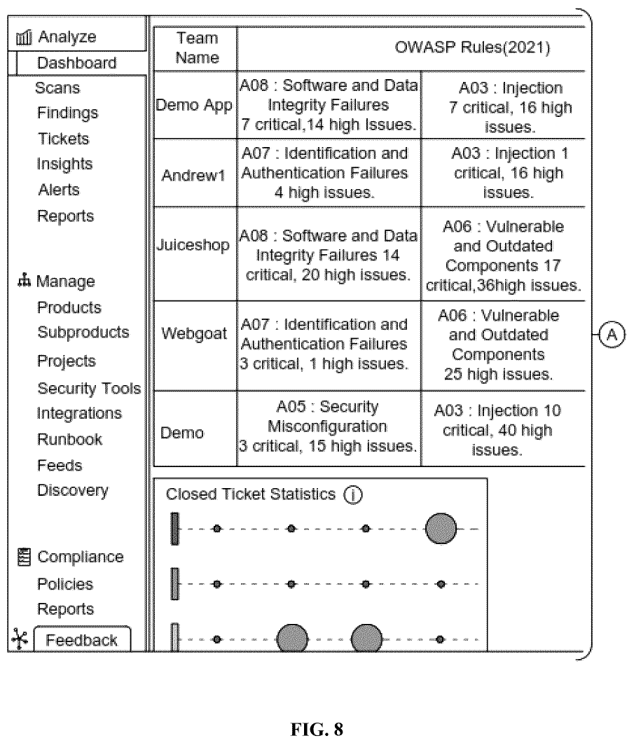

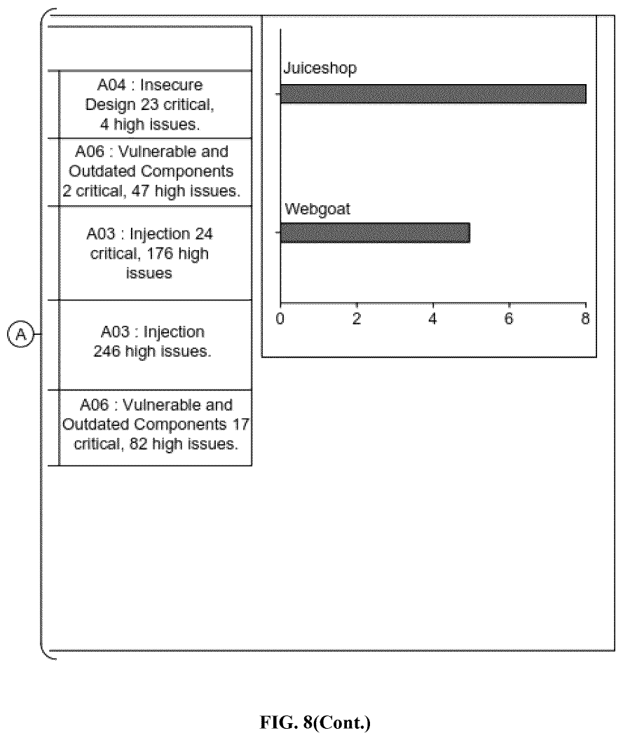

FIG. 8 illustrates a screenshot of team training requirements, in accordance with an embodiment herein. FIG. 8 illustrates the Team name and the OWASTP rules required for training. For instance, for team name Juiceshop: software and data integrity failures are indicated with 14 critical and 20 high issues. Similarly, vulnerable, and outdated components 17 critical and 36 high issues and injection, 24 critical and 176 high issues. FIG. 8 also provides the closed ticket statistics.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail above. It should be understood, however that it is not intended to limit the disclosure to the forms disclosed, but on the contrary, the disclosure is to cover all modifications, equivalents, and alternatives falling within the scope of the disclosure.

The embodiments herein disclose a computer-implemented system and method for developer identification and ticket assignment. The embodiments herein provide several advantages that enhance the efficiency and effectiveness of the security issue resolution process. The advantages include automated developer identification by utilizing owner identification logic and code repository analysis to automatically identify the developer responsible for introducing a security issue. This automated approach eliminates the need for manual investigation, saving time and reducing the chances of human error; Streamlined ticket assignment: by automatically assigning tickets to the developer associated with the vulnerable code section, the embodiment herein streamlines the ticket assignment process. This ensures that the right person is notified promptly, leading to faster resolution of security issues; Seamless integration with version control using the API call through the vulnerability management platform to the code repository allows for seamless integration with version control systems like GitHub and GitLab. This integration enables real-time access to code changes and ensures accurate identification of developers; Comprehensive ticket views by offering various ticket views, such as Insight view, CTO view, Engineering Manager view, Developer view, catering to different stakeholders. These views provide comprehensive insights into ticket status, progress, and security issue resolution from different perspectives, improving communication and collaboration among team members and management; Effective training requirements: by linking security vulnerabilities to training categories, enabling personalized and relevant training requirements for developers. By associating specific training needs with the vulnerabilities they introduced, the invention ensures developers receive targeted education to improve their secure coding practices; Training effectiveness assessment: for assessing training effectiveness allows organizations to measure the impact of training programs accurately. By tracking post-training code changes and identifying gaps, the embodiments herein helps refine the training strategy and promote continuous improvement in security awareness; OWASP Mapping for Training: which is the alignment of the default training categories with the OWASP Top Ten offers a standardized and well-recognized framework for identifying relevant training needs. This approach leverages industry best practices and ensures that developers are equipped to address common web application security risks; Enhanced Accountability: By associating developers with the specific code sections they modified, the embodiments herein promote accountability and ownership of security issues. Developers become more aware of the consequences of their code changes, fostering a culture of responsibility for application security; Centralized Platform: the use of the vulnerability management platform provides a centralized hub for managing security issues, training requirements, and ticket statuses. This centralized approach simplifies oversight, reporting, and monitoring of security-related activities; and data-driven training programs: focusing on aggregating training data provides valuable insights into the effectiveness of training programs at both individual and team levels. This data-driven approach facilitates evidence-based decisions to improve training content and delivery. Hence the embodiments herein bring automation, efficiency, accountability, and data-driven insights to the developer identification and ticket assignment process in the context of application security. By leveraging these advantages, organizations can bolster their security practices, reduce vulnerability resolution time, and foster a security-aware development culture.

Although the embodiments herein are described with various specific embodiments, it will be obvious for a person skilled in the art to practice the embodiments herein with modifications.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phrases or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A method for developer identification and ticket assignment, the method comprises:
a. applying an owner identification logic through a plurality of application security testing methodologies; and wherein the plurality of application security testing methodologies comprises Static Application Security Testing (SAST), Dynamic Application Security Testing (DAST), and Software Composition Analysis (SCA) tool;
b. making an Application Programming Interface (API) call through a vulnerability management platform, to a code repository, where a codebase is stored, to identify the changes made by a developer to the code recently;
c. assigning a ticket to the identified developer and saving a developer information in the vulnerability management platform;
d. viewing the status of the ticket through a plurality of views; and wherein the plurality of views comprises an insight view, a CTO view, an engineering manager view, and a developer view; and
e. providing training requirements and assessing the effectiveness of the training provided.

2. The method according to claim 1, wherein the owner identification logic involves utilizing data from the plurality of application security testing methodologies in conjunction with the information obtained from the code repository to identify an exact line number of a code, where a security issue is found or vulnerability dependency is defined; and wherein the SAST application security testing methodology is configured to identify vulnerability dependency on an exact line number of the code; and wherein the DAST application security testing methodology is configured to identify vulnerability dependency on the codebase and file or line of code, and using the line of code and the API call to identify the developer who committed the code using the line of code; and wherein the SCA tool is configured to identify the vulnerability dependency and license issues in an open source and software libraries, or components included in the codebase.

3. The method according to claim 1, wherein the Application Programming Interface (API) call made through the vulnerability management platform retrieves the information about the recent changes made to the codebase of the code repository, and also identifies which developer has made changes to the portion of the codebase where the security issue is found or the vulnerability dependency is defined.

4. The method according to claim 1, wherein the ticket assigned to the identified developer is updated in a tracking system to track the security issue and its resolution; and wherein the security issue is assigned to the identified developer for further investigation and resolution.

5. The method according to claim 1, wherein the ticket is directly assigned to the identified developer, if the identified developer is registered on the vulnerability management platform; and wherein an email address is used for ticket assignment and identification, if the identified developer is not registered on the vulnerability management platform.

6. The method according to claim 1, wherein the developer information includes the developer who last amended the code or file or code repository; and wherein if the developer information is not available on the vulnerability management platform, then an engineering owner of a product or security owner or business owner as configured during product creation is assigned the ticket, and in default a default assignee or the developer as configured in a rulebook is also assigned with the ticket.

7. The method according to claim 1, wherein the plurality of views are interfaces or different perspectives within the vulnerability management platform, that cater to specific stakeholders involved in the security issue resolution process, and each of the plurality of views provides relevant information and functionalities tailored to the needs of the respective role.

8. The method according to claim 1, wherein the insight view is a high-level overview or dashboard within the vulnerability management platform that provides a comprehensive summary of the overall security posture of the codebase; and wherein the insight view is configured to provide findings by the developers, for creating one ticket for multiple findings and assigning to the developer directly; and wherein the insight view is typically designed for executives, security leaders, or other high-level stakeholders who need a quick and easily digestible snapshot of the security status of the organization's software projects; and wherein the insight view includes metrics, charts, and graphs to represent the number of open security issues, their severity, trends over time, and other key security-related data; and wherein the insight view enables decision-makers to assess the overall security health of the software projects and take appropriate actions or allocate resources as needed.

9. The method according to claim 1, wherein the Chief Technology Officer (CTO) view is a specific interface within the vulnerability management platform tailored for the CTO or other high-level technology executives, and the CTO view is configured to provide individual teams' performance information including the teams that are doing an excellent job of writing secure code and the teams that are not performing well; and wherein the CTO view provides a more detailed and strategic perspective compared to the insight view, focusing on the security status and progress of various projects and teams under the CTO's purview; and wherein the CTO view also offers aggregated metrics for multiple projects, allowing the CTO to evaluate the organization's security initiatives, identify potential areas of concern, and make strategic decisions related to security investments, team training, and project priorities.

10. The method according to claim 1, wherein the Engineering Manager view is configured to provide the engineering manager, the team's performance at a developer level; and wherein the Engineering Manager view provides a more granular and operational level of information related to security issues and tickets assigned to their teams; and wherein the Engineering manager view is used by the Engineering managers to track the progress of security issue resolutions, monitor the workload and performance of their team members, and ensure that security priorities align with project timelines.

11. The method according to claim 1, wherein the developer view is a user interface specifically tailored for individual developers who are assigned tickets to address the security issues; and wherein the developer view also provides details of the security issues assigned to them, including the exact line number of the code where the security issue is found, along with any supporting information from the plurality of application security testing methodologies; and wherein the developers uses the developer view to access the necessary information to understand the security issue, review any relevant testing results, work on resolving the issue in the codebase; and also to update the ticket status, communicate with other team members, and provide feedback or additional information related to the security issue; and wherein the developer view also provides information on individual training requirements to the developer, coding improvement over time with respect to writing secure code.

12. The method according to claim 1, wherein the steps of providing training requirements and assessing the effectiveness of the training, comprises the steps of:
a. mapping vulnerabilities or security issues to a training category; and wherein the mapping the security issues to training category involves mapping each of the security issue to a corresponding training category, to determine the type of training needed to address and prevent similar security issues in the future;
b. identifying individual training requirements; and wherein the individual training requirements is determined by the CTO for an individual developer; and wherein the individual training provides an identified individual developer who modified the code and introduced a particular security vulnerability, the classification system pinpoints the type of training the individual developer needs, to write more secure code;
c. evaluating training effectiveness;
d. recording the training provided and progress; and
e. aggregating training effectiveness data; and wherein the aggregation of training effectiveness data allows the vulnerability management platform to identify specific training areas or categories where improvements are needed at both an individual and team level.

13. The method according to claim 1, wherein the evaluating training effectiveness involves monitoring the developers who received training on specific security topics, and assessing the developer on subsequent code changes, if similar vulnerabilities are still introduced or if improvements are observed post-training; and wherein by assessing the developer post-training and by measuring the type of security issues introduced by the same developer after training, and mapping the security issues to the training category the developer received, the vulnerability management platform identifies gaps in knowledge or assess the effectiveness of the training provided.

14. The method according to claim 12, wherein the recording of the training provided and progress involves capturing training details including training date, type of training, and attendees; and wherein the recording training events and progress also enable easy tracking of individual developer's progress over time, indicating how their coding practices have improved post-training.

15. The method according to claim 1, wherein the vulnerability management platform also provides an option of auto-suggest/assignment of the owner, while creating a ticket manually; and wherein the auto-suggestion of the owner of a ticket is performed when the ticket is created automatically through the runbook; and wherein the auto-suggestion of the owner for the ticket created manually is based on the code analysis of which developer made the last change just before the vulnerability or security issue is introduced.

16. The method according to claim 15, wherein the steps of auto suggesting owner, while creating a ticket manually, comprises the steps of:
a. identifying the vulnerability or security issue by the vulnerability management platform, when a user creates a new ticket to address the security issues; and wherein the ticket created comprises the information about the nature of the issue, including a description of the problem and possibly the exact line number or code section where the vulnerability or the security issues is found;
b. analyzing the code history to trace the changes made to the affected code section over time; and wherein the analyzing the code history involves identifying the last developer or team member who made a code change to the specific line number or code section just before the vulnerability dependency or the security issue is introduced;
c. suggesting the developer as a potential assignee, who made the last code change before the vulnerability is introduced to the ticket; and
d. reviewing the suggested potential assignee and deciding whether to accept auto-suggestion or manual adjustments by the user who created the ticket; and wherein the auto-suggest feature offers the last developer as the initial recommendation; and wherein the user has the flexibility to override the auto-suggestion and manually assign the ticket to a different developer.

17. A computer-implemented system for developer identification and ticket assignment, comprising:
a. an application security testing module configured to apply an owner identification logic through a plurality of application security testing methodologies; and wherein the plurality of application security testing methodologies comprises Static Application Security Testing (SAST), Dynamic Application Security Testing (DAST), and Software Composition Analysis (SCA) tool;
b. a vulnerability management module configured to make an Application Programming Interface (API) call through a vulnerability management platform, to a code repository, where a codebase is stored, to identify the changes made by a developer to the code recently;
c. a ticketing management module configured to assign a ticket to the identified developer and saving a developer information in the vulnerability management platform of the vulnerability management module, and to view the status of the ticket through a plurality of views; and wherein the plurality of views comprises an insight view, a CTO view, an engineering manager view, and a developer view; and
d. a training module configured to provide training requirements and assess the effectiveness of the training provided.

18. The system according to claim 17, wherein the application security testing module applies the owner identification logic for utilizing data from the plurality of application security testing methodologies in conjunction with the information obtained from the code repository to identify an exact line number of a code, where a security issue is found or vulnerability dependency is defined; and wherein the SAST application security testing methodology is configured to identify vulnerability dependency on an exact line number of the code; and wherein the DAST application security testing methodology is configured to identify vulnerability dependency on the codebase and file or line of code, and using the line of code and the API call to identify the developer who committed the code using the line of code; and wherein the SCA tool is configured to identify the vulnerability dependency and license issues in an open source and software libraries, or components included in the codebase.

19. The system according to claim 17, wherein the Application Programming Interface (API) call made through the vulnerability management platform embedded in the vulnerability management module, retrieves the information about the recent changes made to the codebase of the code repository, and also identifies which developer has made changes to the portion of the codebase where the security issue is found or the vulnerability dependency is defined.

20. The system according to claim 17, wherein the ticketing management module updates the ticket assigned to the identified developer in a tracking system to track the security issue and its resolution; and wherein the security issue is assigned to the identified developer for further investigation and resolution.

21. The system according to claim 17, wherein the ticket is directly assigned to the identified developer, if the identified developer is registered on the vulnerability management platform embedded in the vulnerability management module; and wherein an email address is used for ticket assignment and identification if the identified developer is not registered on the vulnerability management platform embedded in the vulnerability management module.

22. The system according to claim 17, wherein the developer information includes the developer who last amended the code or file or code repository; and wherein if the developer information is not available on the vulnerability management platform, then an engineering owner of a product or security owner or business owner as configured during product creation is assigned the ticket, and in default a default assignee or the developer as configured in a rulebook is also assigned with the ticket.

23. The system according to claim 17, wherein the plurality of views to view the status of the ticket assigned by the ticketing management module are interfaces or different perspectives within the vulnerability management platform, that cater to specific stakeholders involved in the security issue resolution process, and each of the plurality of views provides relevant information and functionalities tailored to the needs of the respective role.

24. The system according to claim 17, wherein the insight view is a high-level overview or dashboard within the vulnerability management platform that provides a comprehensive summary of the overall security posture of the codebase; and wherein the insight view is configured to provide findings by the developers, for creating one ticket for multiple findings and assigning to the developer directly; and wherein the insight view is typically designed for executives, security leaders, or other high-level stakeholders who need a quick and easily digestible snapshot of the security status of the organization's software projects; and wherein the insight view include metrics, charts, and graphs to represent the number of open security issues, their severity, trends over time, and other key security-related data; and wherein the insight view enables decision-makers to assess the overall security health of the software projects and take appropriate actions or allocate resources as needed.

25. The system according to claim 17, wherein the Chief Technology Officer (CTO) view is a specific interface within the vulnerability management platform tailored for the CTO or other high-level technology executives, and the CTO view is configured to provide individual teams' performance information including the teams that are doing an excellent job of writing secure code and the teams that are not performing well; and wherein the CTO view provides a more detailed and strategic perspective compared to the insight view, focusing on the security status and progress of various projects and teams under the CTO's purview; and wherein the CTO view also offers aggregated metrics for multiple projects, allowing the CTO to evaluate the organization's security initiatives, identify potential areas of concern, and make strategic decisions related to security investments, team training, and project priorities.

26. The system according to claim 17, wherein the Engineering Manager view is configured to provide the engineering manager, the team's performance at a developer level; and wherein the Engineering Manager view provides a more granular and operational level of information related to security issues and tickets assigned to their teams; and wherein the Engineering manager view is used by the Engineering managers to track the progress of security issue resolutions, monitor the workload and performance of their team members, and ensure that security priorities align with project timelines.

27. The system according to claim 17, wherein the developer view is a user interface specifically tailored for individual developers who are assigned tickets to address the security issues; and wherein the developer view also provides details of the security issues assigned to them, including the exact line number of the code where the security issue is found, along with any supporting information from the plurality of application security testing methodologies; and wherein the developers uses the developer view to access the necessary information to understand the security issue, review any relevant testing results work on resolving the issue in the codebase; and also to update the ticket status, communicate with other team members, and provide feedback or additional information related to the security issue; and wherein the developer view also provides information on individual training requirements to the developer, coding improvement over time with respect to writing secure code.

28. The system according to claim 17, wherein the training module while providing training requirements and assessing the effectiveness of the training is configured for:
a. mapping vulnerabilities or security issues to a training category; and wherein the mapping the security issues to training category involves mapping each of the security issue to a corresponding training category, to determine the type of training needed to address and prevent similar security issues in the future;
b. identifying individual training requirements; and wherein the individual training requirements is determined by the CTO for an individual developer; and wherein the individual training provides an identified individual developer who modified the code and introduced a particular security vulnerability, the classification system pinpoints the type of training the individual developer needs, to write more secure code;
c. evaluating training effectiveness;
d. recording the training provided and progress; and
e. aggregating training effectiveness data; and wherein the aggregation of training effectiveness data allows the vulnerability management platform to identify specific training areas or categories where improvements are needed at both an individual and team level.

29. The system according to claim 17, wherein the training module, is configured to evaluate an effectiveness of training given by imonitoring the developers who received training on specific security topics, and assessing the developer on subsequent code changes, if similar vulnerabilities are still introduced or if improvements are observed post-training; and wherein by assessing the developer post-training and by measuring the type of security issues introduced by the same developer after training, and mapping the security issues to the training category the developer received, the vulnerability management platform identifies gaps in knowledge or assess the effectiveness of the training provided.

30. The system according to claim 28, wherein the training module is configured to the training and progress by capturing training details including training date, type of training, and attendees; and wherein the recording training events and progress also enables easy tracking of individual developer's progress over time, indicating how their coding practices have improved post-training.

31. The system according to claim 17, wherein the vulnerability management platform embedded in the vulnerability management module also provides an option of auto suggest/assignment of owner, while creating a ticket manually; and wherein the auto-suggestion of the owner of a ticket is performed, when the ticket is created automatically through the runbook; and wherein the auto suggestion of owner for the ticket created manually is based on the code analysis of which developer made the last change just before the vulnerability or security issue is introduced.

32. The system according to claim 31, wherein the vulnerability management module is configured to auto-suggest owner while creating a ticket manually, by:
a. identifying the vulnerability or security issue by the vulnerability management platform, when a user creates a new ticket to address the security issues; and wherein the ticket created comprises the information about the nature of the issue, including a description of the problem and possibly the exact line number or code section where the vulnerability or the security issues is found;
b. analyzing the code history to trace the changes made to the affected code section over time; and wherein the analyzing the code history involves identifying the last developer or team member who made a code change to the specific line number or code section just before the vulnerability dependency or the security issue is introduced;
c. suggesting the developer as a potential assignee, who made the last code change before the vulnerability is introduced to the ticket; and
d. reviewing the suggested potential assignee and deciding whether to accept auto-suggestion or manual adjustments by the user who created the ticket; and wherein the auto-suggest feature offers the last developer as the initial recommendation; and wherein the user has the flexibility to override the auto-suggestion and manually assign the ticket to a different developer.
